(19) United States
(12) Patent Application Publication
(10) Pub. No.: US 2018/0114295 A1
(43) Pub. Date: Apr. 26, 2018

(54) TRANSMISSION CONTROL METHOD AND TRANSMISSION CONTROL DEVICE

(71) Applicant: FUJITSU LIMITED, Kawasaki-shi (JP)

(72) Inventor: IORI MURAKAMI, Yokohama (JP)

(73) Assignee: FUJITSU LIMITED, Kawasaki-shi (JP)

(21) Appl. No.: 15/726,072

(22) Filed: Oct. 5, 2017

(30) Foreign Application Priority Data
Oct. 25, 2016 (JP) 2016-208967

(51) Int. Cl. G06T 3/40

(52) U.S. Cl. CPC G06T 3/4092; H04B 1/02; G06T 2200/16

(57) ABSTRACT

A transmission control method executed by a computer. The method includes transmitting first image information that is displayed on a head mounted display to a terminal, extracting, when designation information for designating a first range included in the first image information is received from the terminal, second image information corresponding to the first range from the first image information, and transmitting the second image information to the terminal.

### CROSS-REFERENCE TO RELATED APPLICATION

This application is based upon and claims the benefit of priority of the prior Japanese Patent Application No. 2016-208967, filed on Oct. 25, 2016, the entire contents of which are incorporated herein by reference.

### FIELD

The embodiments discussed herein are related to a transmission control program, a transmission control method, and an information processing device.

### BACKGROUND

In recent years, it has been proposed to perform a maintenance operation of, for example, a factory or the like using a head mounted display (which will be hereinafter also referred to as a “HMD”). In such a case, an HMD is coupled to a terminal held by an operator and displays a screen of an application that operates in the terminal. There is a case in which, in the HMD, it is requested to set various settings at an HMD side. In this case, an operation is performed by transferring the screen of the HMD to the terminal and performing a remote operation on the HMD from the terminal. Also, it has been proposed to generate an image that is displayed by a stationary terminal or an eyeglass type terminal and to transmit the image in accordance with an operation at an operation terminal.

Technologies relating to this are disclosed in, for example, Japanese Laid-open Patent Publication No. 2015-215465 and Japanese Laid-open Patent Publication No. 07-104210.

### SUMMARY

According to an aspect of the invention, a transmission control method includes transmitting first image information that is displayed on a head mounted display to a terminal, extracting, when designation information for designating a first range included in the first image information is received from the terminal, second image information corresponding to the first range from the first image information, and transmitting the second image information to the terminal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of a transmission control system according to an embodiment;

FIG. 2 is a view illustrating an example in which an entire image is reduced and the reduced image is transmitted;

FIG. 3 is a view illustrating an example in which an image is magnified in a terminal device;

FIG. 4 is a sequence diagram illustrating an example of transmission control processing according to an embodiment; and

FIG. 5 is a block diagram illustrating an example of a computer that executes a transmission control program.

### DESCRIPTION OF EMBODIMENTS

In related art, for example, in some cases, when, in wirelessly transferring a screen in order to perform a remote operation on a HMD from a terminal, the resolution of the screen that is transferred is set low because of constraints on a transfer rate, characters on the screen are faint and readability is reduced. In contrast, in other cases, when the resolution of a screen that is transferred is set high, a frame rate is reduced and the amount of data that is transferred is increased.

Embodiments of a transmission control program, a transmission control method, and an information processing device disclosed herein will be described in detail below with reference to the accompanying drawings. Note that a technology disclosed herein is not limited to the embodiments below. Also, the following embodiments may be combined, as appropriate, to the extent that there is no contradiction.

### Embodiments

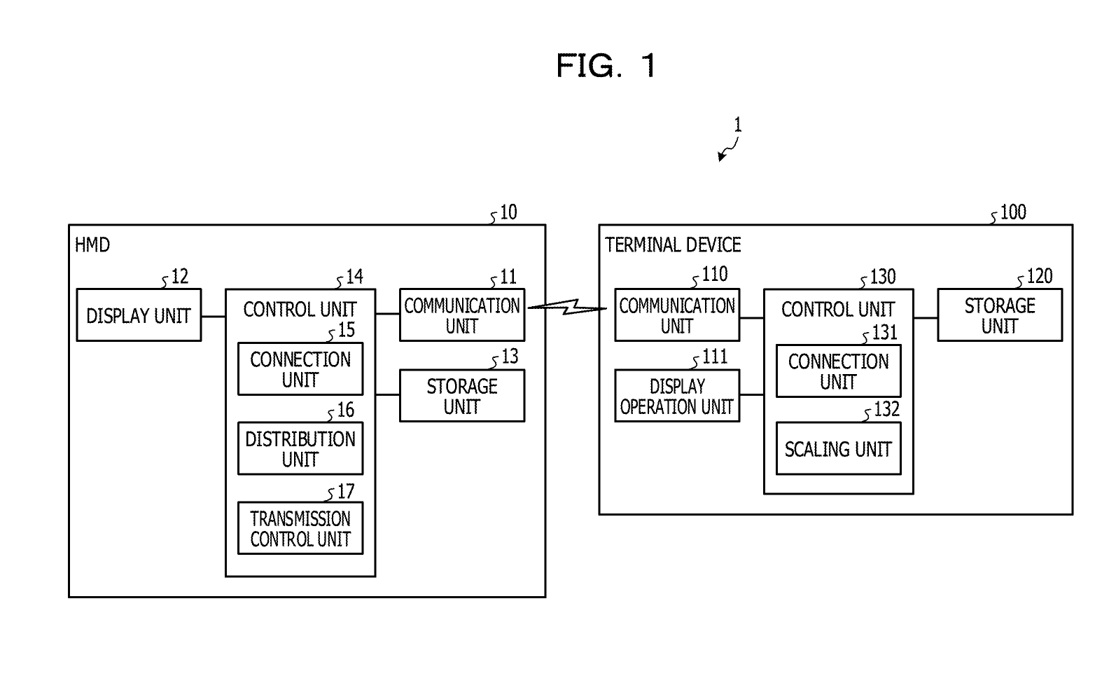

FIG. 1 is a block diagram illustrating an example of a configuration of a transmission control system according to an embodiment. A transmission control system 1 illustrated in FIG. 1 includes a HMD 10 and a terminal device 100. The HMD 10 and the terminal device 100 are wirelessly coupled to one another, for example, in one-to-one correspondence. That is, the HMD 10 may be caused to function as an example of a display unit of the terminal device 100. Also, in a state in which the HMD 10 is coupled to the terminal device 100, the HMD 10 transfers image information, that is, a screen, which is displayed on the HMD 10, to the terminal device 100 so that the screen that has been transferred is shared by the terminal device 100, and thus, is enabled to be remotely operated. Note that, although, in FIG. 1, for a pair of the HMD 10 and the terminal device 100, a single pair thereof is illustrated as an example, the number of pairs of the HMD 10 and the terminal device 100 is not limited thereto and the transmission control system 1 may be configured to include an arbitrary number of pairs of the HMD 10 and the terminal device 100.

The HMD 10 and the terminal device 100 are coupled to one another via a wireless local area network (LAN), such as, for example, Wi-Fi Direct (registered trademark) or the like, so as to be mutually communicable with one another. Note that the HMD 10 and the terminal device 100 may be coupled to one another via a wire.

The HMD 10 is an information processing device which is worn by a user with the terminal device 100 and displays a display screen that is transmitted from the terminal device 100 on a display unit. Note that the user may wear the HMD 10 alone. Also, the HMD 10 transmits image information, that is, a screen, which is displayed on the HMD 10, to the terminal device 100 in a state in which the HMD 10 is coupled to the terminal device 100. For the HMD 10, for example, a single-eye transmission-type HMD may be used. Note that, for the HMD 10, various types of HMDs, such as, for example, a both-eye immersion-type HMD, or the like, may be used. Also, as long as the HMD 10 is a display that is mounted on the head, various types of HMDs, such as an eyeglass-type HMD, a hat-type HMD, or the like, may be used.

Also, when the HMD 10 receives information that designates a range of image information that has been transmitted by the terminal device 100, the HMD 10 extracts image information in a range that corresponds to the received information among image information that is displayed on the display unit of the HMD 10. The HMD 10 transmits the extracted image information to the terminal device 100. Thus, the HMD 10 is enabled to reduce increase in the amount of data that is transmitted to the terminal device 100.

The terminal device 100 is an example of a display terminal and, for example, is an information processing device that the user wears and operates. For the terminal device 100, for example, a mobile communication terminal or the like, such as a tablet terminal, a smartphone, or the like, may be used. When the terminal device 100 receives image information, for example, from the HMD 10, the terminal device 100 displays the received image information on the display unit to share the image information, that is, the screen, with the HMD 10. When the terminal device 100 receives an image scaling operation from the user, the terminal device 100 acquires a scaling ratio based on the scaling operation and transmits designation information that includes the scaling ratio and designates a range to the HMD 10. The terminal device 100 receives image information in a range that corresponds to the designation information from the HMD 10 and displays the image information.

Next, a configuration of the HMD 10 will be described. As illustrated in FIG. 1, the HMD 10 includes a communication unit 11, a display unit 12, a storage unit 13, and a control unit 14. Note that the HMD 10 may be configured to further include, in addition to the above-described function units illustrated in FIG. 1, a function unit, such as, for example, various types of input devices, sound output devices, or the like.

The communication unit 11 is realized by a communication module or the like, such as, for example, a wireless LAN or the like. The communication unit 11 is a communication interface that is wirelessly coupled to the terminal device 100, for example, via Wi-Fi Direct (registered trademark) and communicates information with the terminal device 100. The communication unit 11 transmits image information that has been input from the control unit 14 and is displayed on the display unit 12 or extracted image information to the terminal device 100. Also, the communication unit 11 receives a connection request that causes sharing of a screen, designation information that designates a range of image information, and operation information from the terminal device 100. The communication unit 11 outputs the connection request, the designation information, and the operation information, which have been received, to the control unit 14.

The display unit 12 is a display device that displays various types of information. The display unit 12 corresponds to, for example, a display element of a transmission-type HMD in which a picture image is projected on a half mirror and through which the user is able to view outside scenery with the picture image. Note that the display unit 12 may be a display element that corresponds to an immersion-type HMD, a video-transmission-type HMD, a retinal-projection-type HMD, or the like.

The storage unit 13 is realized by a storage device, such as, a semiconductor memory element or the like, such as, for example, a random access memory (RAM), a flash memory, or the like. The storage unit 13 stores information used for processing in the control unit 14.

The control unit 14 is realized by causing, for example, a central processing unit (CPU), a micro processing unit (MPU), or the like to execute a program stored in an internal storage device in the RAM as an operation area. Also, the control unit 14 may be realized by an integrated circuit, such as, for example, an application specific integrated circuit (ASIC), a field programmable gate array (FPGA), or the like.

The control unit 14 includes a connection unit 15, an extraction unit 16, and a transmission control unit 17 and realizes or executes a function or an operation of information processing described below. Note that an internal configuration of the control unit 14 is not limited to the configuration illustrated in FIG. 1 and the control unit 14 may be formed to have some other configuration, as long as the control unit 14 is configured to perform information processing which will be described later. Also, for example, when the power of the HMD 10 is turned on, the control unit 14 causes the display unit 12 to display image information, such as an initial screen, a menu screen, or the like.

The connection unit 15 establishes a connection with the terminal device 100. When the connection unit 15 receives a connection request that causes sharing of a screen from the terminal device 100 via the communication unit 11, for example, in a state in which an operation unit (not illustrated) is operated and waits for being coupled, the connection unit 15 establishes a connection with the terminal device 100, for example, via Wi-Fi Direct (registered trademark). When a connection to the terminal device 100 is established, the connection unit 15 sets an extraction range that is extracted from image information that is displayed by the display unit 12 to an initial value. The initial value of the extraction range may be set to an image size of, for example, VGA (640 pixels×480 pixels), for example, among a plurality of display resolutions that may be set for the display unit 12. That is, the initial value of the extracted range is a length of 0.0 to 1.0/a breadth of 0.0 to 1.0 in terms of the scaling ratio. Note that the initial value of the extraction range is not limited to the display resolution of the display unit 12. The connection unit 15 outputs the extraction range that has been set to the initial value to the extraction unit 16.

Also, when the connection unit 15 receives operation information from the terminal device 100 via the communication unit 11, the connection unit 15 receives an input of the received operation information. That is, the HMD 10 receives a remote operation from the terminal device 100.

When the extraction range that has been set to the initial value is input from the 15, the extraction unit 16 reduces, if the image information that is displayed on the display unit 12 is larger than the extraction range that has been input, the image information to the extraction range and sets the reduced image information as extracted image information. For example, assuming that the initial value of the extraction range is VGA and the image information that is displayed on the display unit 12 is XGA (1024 pixels×768 pixels), the extraction unit 16 reduces the image information from XGA to VGA and sets the reduced image information as extracted image information. If image information that is displayed on the display unit 12 has a size equal to or less than the extraction range that has been input, the extraction unit 16 does not reduce the image information and sets the image information as it is as extracted image information. The extraction unit 16 outputs the extracted image information to the transmission control unit 17.

Also, the extraction unit 16 determines whether or not designation information that designates a range of image information has been received from the terminal device 100. If the designation information has not been received, the extraction unit 16 continuously outputs extracted image information that corresponds to the extraction range that has been set to the initial value to the transmission control unit 17. If the designation information has been received, the extraction unit 16 calculates an extraction range, based on the received designation information. The designation information that designates a range of image information may be represented, for example, by a scaling ratio of a rectangle. The scaling ratio of a rectangle may be represented, for example, by a scaling ratio [(x lower limit, y lower limit), (x upper limit, y upper limit)]. Also, the extraction range may be calculated from the image size of image information that is displayed on the display unit 12 and the scaling ratio in accordance with Expression 1 below.

Extraction range=image size(x,y)×Scaling ratio[(x lower limit,y lower limit),(x upper limit,y upper limit)] (Expression 1)

For example, when the image size of image information that is displayed on the display unit 12 is VGA and the scaling ratio is a length of 0.25 to 0.75/a breadth of 0.25 to 0.75, the extraction range is a value represented by Expression (2) below.

Extraction range=image size(640,480)×Scaling ratio[(0.25,0.25),(0.75,0.75)]=[(160,120),(480,360)] (Expression 2)

The extraction unit 16 extracts, based on the calculated extraction range, image information that corresponds to the extraction range from the image information that is displayed on the display unit 12.

The extraction unit 16 determines whether or not the extracted image information exceeds a certain image size. In this case, the certain image size may be, for example, QVGA (320 pixels×240 pixels). If the extracted image information exceeds the certain image size, the extraction unit 16 reduces the extracted image information to the certain image size and outputs the reduced image information to the transmission control unit 17. If the extracted image information does not exceed the certain image size, the extraction unit 16 does not reduce the extracted image information and outputs the extracted mage information as it is to the transmission control unit 17. In the example of Expression 2 described above, the extraction range is 320 pixels×240 pixels, and therefore, the extracted image information is output as it is to the transmission control unit 17.

In other words, when the extraction unit 16 receives information that designates a range of image information that has been transmitted by the terminal device 100, the extraction unit 16 extracts image information in a range that corresponds to the received information among image information that is displayed on the display unit 12 of a head mounted display, that is, the HMD 10. Also, when the extraction unit 16 receives information that designates a range of image information including a certain ratio that indicates scaling of an image in a display area from the terminal device 100, the extraction unit 16 extracts image information in a range based on the image size of the image information before scaling and the certain ratio. Note that designation information in this embodiment is an example of information that designates the range of image information. Furthermore, if the extracted image information exceeds a certain image size, the extraction unit 16 reduces the extracted image information to the certain image size.

When the extracted image information is input from the extraction unit 16, the transmission control unit 17 starts transmission of the input image information to the terminal device 100 via the communication unit 11. Also, the transmission control unit 17 determines whether or not information that terminates screen sharing has been received or input from the operation unit (not illustrated) of the terminal device 100 or the HMD 10. That is, the transmission control unit 17 determines whether or not screen sharing is to be terminated. If screen sharing is not to be terminated, the transmission control unit 17 sequentially continues transmission of image information. If screen sharing is to be terminated, the transmission control unit 17 terminates transmission control processing and stops transmission of image information.

Subsequently, a configuration of the terminal device 100 will be described. As illustrated in FIG. 1, the terminal device 100 includes a communication unit 110, a display operation unit 111, a storage unit 120, and a control unit 130. Note that the terminal device 100 may be configured to further include, in addition to the function units illustrated in FIG. 1, various types of function units, that is, for example, function units, such as various types of input devices, sound devices, or the like, which are included in a known computer.

The communication unit 110 is realized, for example, by a communication module or the like, such as a wireless LAN or the like. The communication unit 110 is a communication interface that is wirelessly coupled to the HMD 10, for example, via Wi-Fi Direct (registered trademark) and communicates information with the HMD 10. The communication unit 110 receives image information from the HMD 10. The communication unit 110 outputs the received image information to the control unit 130. Also, the communication unit 110 transmits a connection request that causes sharing of a screen, designation information that designates a range of image information, and operation information, which have been input from the control unit 130, to the HMD 10.

The display operation unit 111 is an input device that receives various types of operations from a display device that displays various types of information and a user. For example, the display operation unit 111 is realized as a display device by a liquid crystal display or the like. Also, for example, the display operation unit 111 is realized as an input device by a touch panel or the like. That is, the display operation unit 111 is an integrated unit in which the display device and the input device are integrated. The display operation unit 111 outputs, as operation information, an operation that has been input by the user to the control unit 130. Note that, when the display operation unit 111 performs screen sharing with the HMD 10, the display operation unit 111 displays a screen based on image information that has been received from the HMD 10 and, when the display operation unit 111 does not perform screen sharing with the HMD 10, the display operation unit 111 displays a different screen from a screen of the HMD 10.

The storage unit 120 is realized by a storage device, such as, for example, a semiconductor memory element, such as, a RAM, a flash memory, or the like, a hard disk, an optical disk, or the like. The storage unit 120 stores information that is used for processing in the control unit 130.

The control unit 130 is realized by causing, for example, a CPU, an MPU, or the like to execute a program stored in an internal storage unit in the RAM as an operation area. Also, the control unit 130 may be realized by an integrated circuit, such as, for example, an ASIC, an FPGA, or the like. The control unit 130 includes a connection unit 131 and a scaling unit 132 and realizes or executes a function or an operation of information processing described below. Note that an internal configuration of the control unit 130 is not limited to the configuration illustrated in FIG. 1 and the control unit 130 may be formed to have some other configuration, as long as the control unit 13 has a configuration that performs information processing which will be described later.

The connection unit 131 establishes a connection with the HMD 10. For example, when an operation that requests a connection for sharing of a screen is input from the display operation unit 111 by the user, the connection unit 131 transmits a connection request that causes sharing of a screen to the HMD 10 via the communication unit 110. Thereafter, the connection unit 131 establishes a connection with the HMD 10, for example, via Wi-Fi Direct (registered trademark). When the connection unit 131 establishes a connection with the HMD 10, the connection unit 131 starts, via the communication unit 110, reception of image information from the HMD 10 and display on the display operation unit 111. Note that, when operation information for a display screen is input from the display operation unit 111 while screen sharing is performed, the connection unit 131 transmits the input operation information to the HMD 10 via the communication unit 110.

Also, the connection unit 131 determines whether or not information that terminates screen sharing has been input from the display operation unit 111. That is, the connection unit 131 determines whether or not screen sharing is to be terminated. If screen sharing is not to be terminated, the connection unit 131 sequentially continues reception and display of image information and reception of an image scaling operation. If screen sharing is to be terminated, the connection unit 131 terminates processing and stops reception and display of image information and reception of a scaling operation of scaling of an image.

When a connection with the HMD 10 is established by the connection unit 131 and reception and display of image information is started, the scaling unit 132 determines whether or not an image scaling operation that is to be performed on the display operation unit 111 by the user has been received. If the image scaling operation has been received, the scaling unit 132 acquires a scaling ratio based on the scaling operation. Note that examples of the image scaling operation include, for example, an operation called pinch-out in which the user moves two fingers away from one another on the display operation unit 111 to magnify an image or an operation called pinch-in in which the user moves two fingers closer to one another to reduce an image. The scaling unit 132 calculates a scaling ratio, for example, based on the number of pixels of the image before and after the scaling operation, to acquire the scaling ratio. Also, the scaling ratio is an example of a certain ratio that indicates scaling of an image in the display area of the display operation unit 111.

The scaling unit 132 causes the acquired scaling ratio to be included in designation information, as an example of a method for designating a range of image information. The scaling unit 132 transmits the designation information including the scaling ratio to the HMD 10 via the communication unit 110. If an image scaling operation has not been received, the image scaling unit 132 is continuously waits for receiving an image scaling operation.

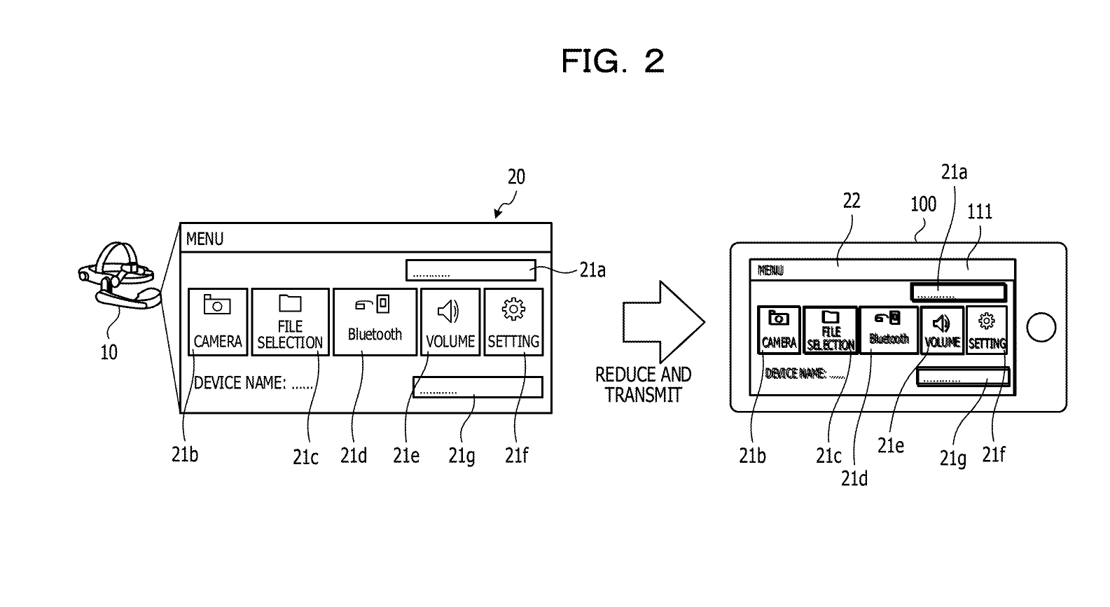

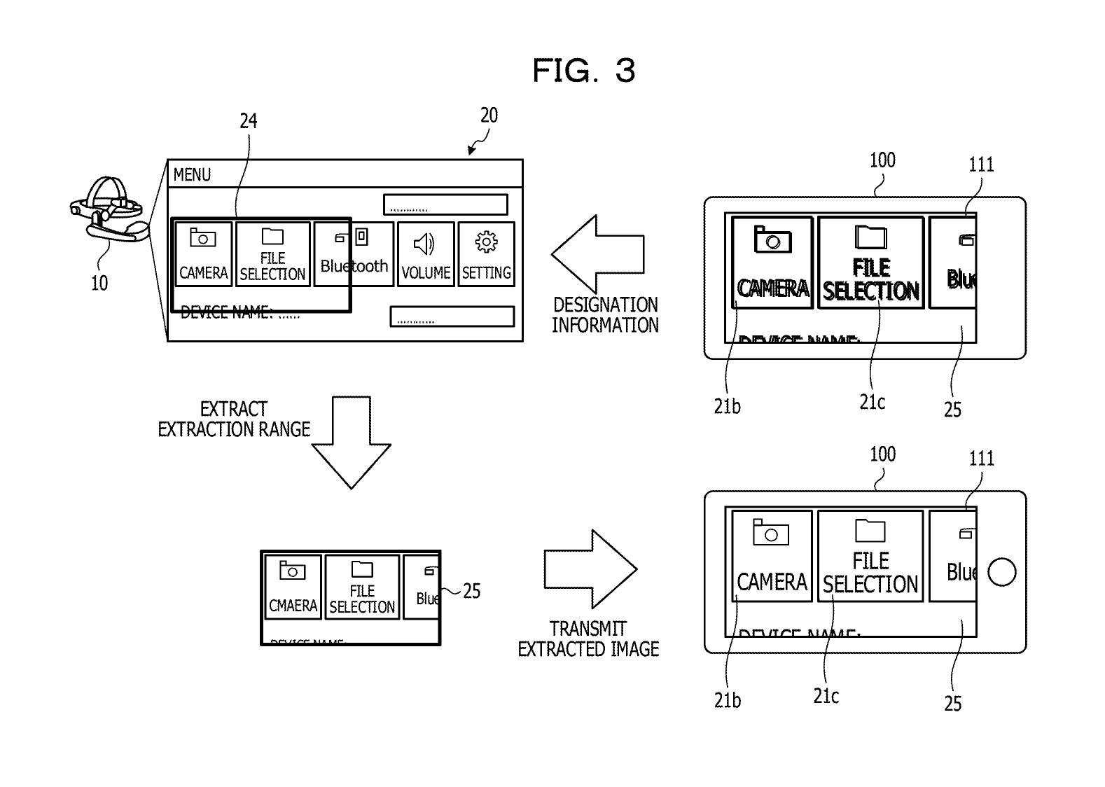

Now, display in accordance with image scaling will be described with reference to FIG. 2 and FIG. 3. FIG. 2 is a view illustrating an example in which an entire image is reduced and the reduced image is transmitted. In the example of FIG. 2, the HMD 10 reduces the entire image information of a menu screen 20 and transmits the reduced entire image information. On the menu screen 20, various operation buttons 21a to 21g are arranged and, for example, an operation button 21b includes characters of “CAMERA”. On a menu screen 22 displayed on the display operation unit 111 of the terminal device 100, the entire image information of the menu screen 20 is reduced. Therefore, the menu screen 22 is in a state in which characters of the operation buttons 21a to 21g, such as, for example, characters of “CAMERA” of the operation button 21b or characters of “FILE SELECTION” of the operation button 21c are blur and hard to read.

FIG. 3 is a view illustrating an example in which an image is magnified in a terminal device. A magnified screen 23 in FIG. 3 is a screen in which an area including the operation buttons 21b and 21c is magnified from the state of FIG. 2 by an operation of pinch-out. In the magnified screen 23, the menu screen 20 in which characters are blur and hard to read is magnified as it is and thus is displayed, so that the characters of “CAMERA” of the operation button 21b and the characters “FILE SELECTION” of the operation button 21c are still blur. When the terminal device 100 receives an operation of pinch-out, the terminal device 100 acquires a scaling ratio and transmits the acquired scaling ratio as designation information to the HMD 10.

When the HMD 10 receives the designation information, the HMD 10 calculates an extraction range 24, based on the designation information, performs extraction, and transmits image information of an extracted image 25 to the terminal device 100. That is, for the extraction range 24, the HMD 10 extracts an image in which characters are easier to read than those in the menu screen 20 and transmits the mage. In the terminal device 100, the image information of the extracted image 25, which has been received, is displayed on the display operation unit 111, and thereby, the characters of “CAMERA” of the operation button 21b and the characters of “FILE SELECTION” of the operation button 21c are displayed so that the characters are not blur but easy to read. As described above, in the transmission control system 1, only for a part of an image, which is desired to be acquired by the terminal device 100, a high-resolution image is transmitted from the HMD 10, and therefore, increase in the amount of data that is transmitted from the HMD 10 to the terminal device 100 may be reduced.

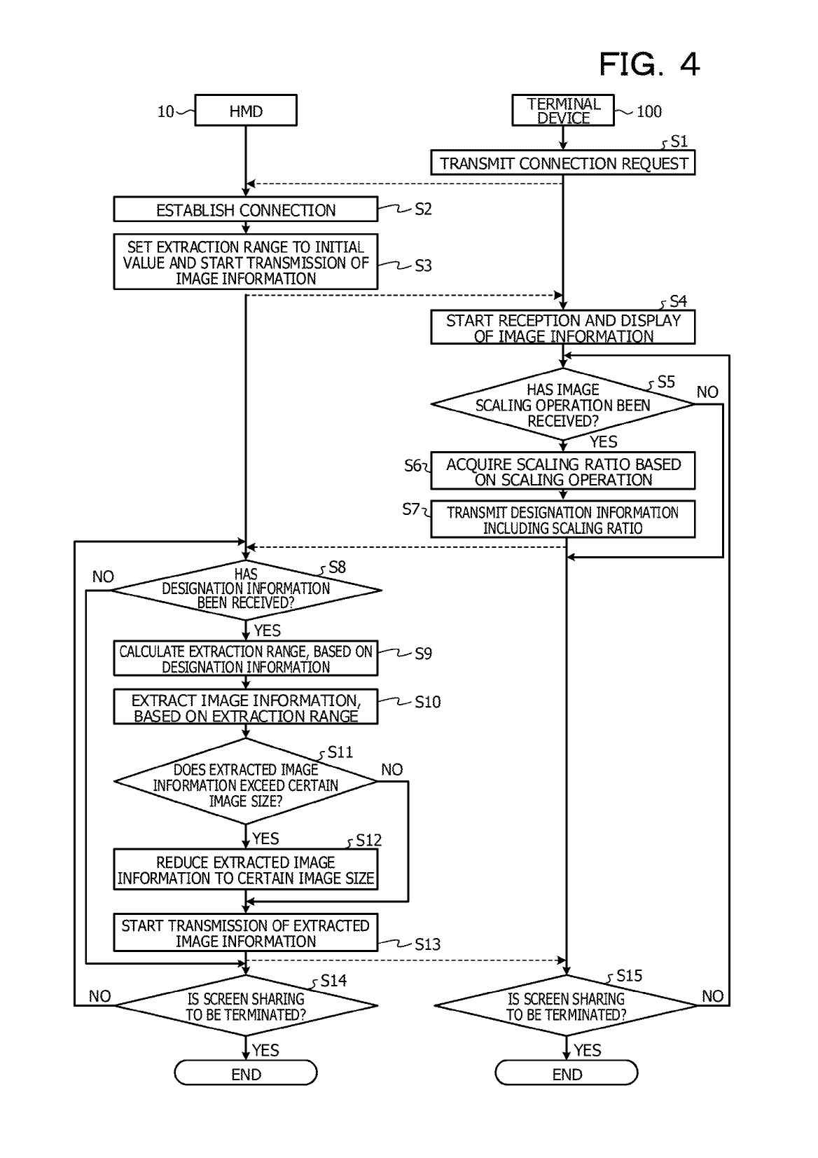

Next, an operation of the transmission control system 1 of the above-described embodiment will be described. FIG. 4 is a sequence diagram illustrating an example of transmission control processing according to an embodiment.

The power of the HMD 10 is tuned on, and then, the HMD 10 causes the display unit 12 to display image information, such as a menu screen, or the like. Also, the connection unit 15 of the HMD 10 waits for a connection from the terminal device 100. For example, when an operation of requesting a connection is input, the connection unit 131 of the terminal device 100 transmits a connection request that causes sharing of a screen to the HMD 10 (Step S1).

When the connection unit 15 of the HMD 10 receives the connection request, the connection unit 15 establishes a connection with the terminal device 100 (Step S2). When a connection with the terminal device 100 is established, the connection unit 15 sets an extraction range that is extracted from image information that is displayed on the display unit 12 to an initial value. The connection unit 15 outputs the extraction range that has been set to the initial value to the extraction unit 16. When the extraction range that has been set to the initial value is input from the connection unit 15, the extraction unit 16 outputs the extraction range, that is, for example, image information of the entire screen, to the transmission control unit 17. The transmission control unit 17 starts transmission of the image information that has been input from the extraction unit 16 to the transmission control unit 17 (Step S3).

When the connection unit 131 of the terminal device 100 establishes a connection with the HMD 10, the connection unit 131 starts reception of the image information from the HMD 10 and display of the image information (Step S4). When a connection with the HMD 10 is established by the connection unit 131 and reception and display of the image information are started, the scaling unit 132 determines whether or not an image scaling operation has been received (Step S5). If an image scaling operation has not been received (NO in Step S5), the scaling unit 132 causes the process to proceed to Step S15.

If an image scaling operation has been received (YES in Step S5), the scaling unit 132 acquires a scaling ratio based on the scaling operation (Step S6). The scaling unit 132 causes the acquired scaling ratio to be included in designation information. The scaling unit 132 transmits the designation information including the scaling ratio to the HMD 10 (Step S7).

The extraction unit 16 of the HMD 10 determines whether or not the designation information has been received from the terminal device 100 (Step S8). If the designation information has not been received from the terminal device 100 (NO in Step S8), the extraction unit 16 causes the process to proceed to Step S14. If the designation information has been received from the terminal device 100 (YES in Step S8), the extraction unit 16 calculates an extraction range, based on the received designation information (Step S9). The extraction unit 16 extracts, based on the calculated extraction range, image information that corresponds to the extracted range from the image information that is displayed on the display unit 12 (Step S10).

The extraction unit 16 determines whether or not the extracted image information exceeds a certain image size (Step S11). If the extracted image information exceeds the certain image size (YES in Step S11), the extraction unit 16 reduces the extracted image information to the certain image size (Step S12) and outputs the reduced image information to the transmission control unit 17. If the extracted image information does not exceed a certain image size (NO in Step S11), the extraction unit 16 does not reduce the extracted image information and outputs the extracted image information as it is to the transmission control unit 17.

The transmission control unit 17 starts transmission of the image information that has been input from the extraction unit 16 to the terminal device 100 (Step S13). Note that, in the terminal device 100, reception and display of the image information have been started in Step S4, and therefore, the image information that is displayed is changed to the image information transmission of which is started in Step S13.

The transmission control unit 17 determines whether or not screen sharing is to be terminated (Step S14). If screen sharing is not to be terminated (NO in Step S14), the transmission control unit 17 causes the process to proceed to Step S8. If screen sharing is to be terminated (YES in Step S14), the transmission control unit 17 terminates transmission control processing and stops transmission of the image information.

The connection unit 131 of the terminal device 100 determines whether or not screen sharing is to be terminated (Step S15). If screen sharing is not to be terminated (NO in Step S15), the connection unit 131 causes the process to return to Step S5. If screen sharing is to be terminated (YES in Step S15), the connection unit 131 terminates processing and stops reception and display of the image information and reception of the image scaling operation. Accordingly, the HMD 10 transmits a high-resolution image only for a part of an image, which is desired to be acquired by the terminal device 100, and thereby, increase in the amount of data that is transmitted to the terminal device 100 may be reduced. That is, the HMD 10 is enabled to automatically adjust a resolution in the terminal device 100 without the user's awareness.

As described above, the HMD 10 transmits the image information that is displayed on the display unit 12 of the HMD 10 to the terminal device 100. Also, when the HMD 10 receives information that designates a range of the image information that has been transmitted by the terminal device 100, the HMD 10 extracts image information in a range that corresponds to the received information among the image information that is displayed on the display unit 12 of the HMD 10. Also, the HMD 10 transmits the extracted image information to the terminal device 100. As a result, increase in the amount of data that is transmitted to the terminal device 100, that is, a display terminal, may be reduced.

Also, when the HMD 10 receives information that designates a range of image information including a certain ratio that indicates scaling of an image in a display area from the terminal device 100, the HMD 10 extracts image information in a range based on the image size of the image information before scaling and the certain ratio. As a result, readability of characters in an image may be increased.

Also, if the extracted image information exceeds the certain image size, the HMD 10 reduces the extracted image information to the certain image size. As a result, image information that corresponds to a scaling amount in the terminal device 100 may be transmitted to the terminal device 100.

Note that, in the above-described embodiment, an example in which a menu screen or the like at the time of setting of the HMD 10 is shared has been described, but the technology disclosed herein is not limited thereto. For example, when a trouble occurs in the HMD 10, an error log or a console screen may be shared. Also, when an application an operation of which is not assumed to be performed in a terminal in which it is not possible to perform a touch panel input is caused to operate in the HMD 10 in which it is not possible to perform a touch panel input, the screen of the HMD 10 may be shared by the terminal device 100, and thus, a remote operation may be performed.

Also, each component element of each unit illustrated in the drawings may or may not be physically configured as illustrated in the drawings. That is, specific embodiments of disintegration and integration of each unit are not limited to those illustrated in the drawings, and all or some of the units may be disintegrated/integrated functionally or physically in an arbitrary unit in accordance with various loads, use conditions, and the like. For example, the extraction unit 16 and the transmission control unit 17 may be integrated. Also, the order of the respective steps illustrated in the drawings is not limited to the above-described order and, to the extent that there is no contradiction, the respective steps may be simultaneously performed and also may be performed in a different order.

Furthermore, all or some of various processing functions that are executed in each device may be executed on a CPU (or a microcomputer, such as a micro processing unit (MPU), a micro controller unit (MCU) or the like). In addition, needless to say, all or arbitrary one or ones of the various processing functions of may be executed on a program that is analyzed and executed on a CPU (or a microcomputer, such as a MPU, a MCU, or the like), or on hardware by wired logic.

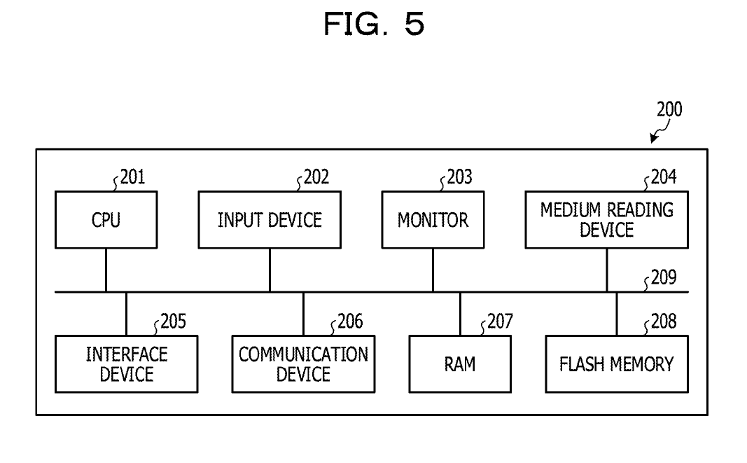

Incidentally, various types of processing, which have been described in the above-described embodiment, may be realized by causing a computer to execute a program prepared in advance. Therefore, an example of a computer that executes a program having similar functions to the functions in the above-described embodiment will be described below. FIG. 5 is a block diagram illustrating an example of a computer that executes a transmission control program.

As illustrated in FIG. 5, a computer 200 includes a CPU 201 that executes various types of arithmetic processing, an input device 202 that receives a data input, and a monitor 203. Also, the computer 200 includes a medium reading device 204 that reads a program or the like from a storage medium, an interface device 205 that is used for providing a connection to various devices, and a communication device 206 that is used for providing a connection with another information processing device or the like wiredly or wirelessly. Also, the computer 200 includes a RAM 207 that temporarily stores various types of information and a flash memory 208. Each of the devices 201 to 208 is coupled to a bus 209.

The transmission control program having a similar function to the function of each of the processing units of the connection unit 15, the extraction unit 16, and the transmission control unit 17 illustrated in FIG. 1 is stored in the flash memory 208. Also, various types of data which are used for realizing the transmission control program are stored in the flash memory 208. The input device 202 receives an input of each of various types of information, such as, for example, operation information or the like, from a user of the computer 200. The monitor 203 has, for example, a similar function to the function of the display unit 12 illustrated in FIG. 1 and displays various screens, such as a display screen or the like, to the user of the computer 200. For example, a microphone, an earphone, or the like is coupled to the interface device 205. The communication device 206 has, for example, a similar function to the function of the communication unit 11 illustrated in FIG. 1, is coupled to the terminal device 100, and exchanges various types of information with the terminal device 100.

The CPU 201 reads each program stored in the flash memory 208, expands the program in the RAM 207 to execute the program, and thereby, performs various types of processing. Also, the programs are capable of causing the computer 200 to function as the connection unit 15, the extraction unit 16, and the transmission control unit 17 illustrated in FIG. 1.

Note that there may be a case in which the above-described transmission control program is not stored in the flash memory 208. For example, a program that is stored in a storage medium that may be read by the computer 200 may be read out and executed by the computer 200. For example, a portable recording medium, such as a CD-ROM, a DVD disk, a universal serial bus (USB) memory, or the like, a semiconductor memory, such as a flash memory, a hard drive, or the like, corresponds to the storage medium that may be read by the computer 200. As another option, the transmission control program may be stored in a device coupled to a public line, the Internet, a LAN, or the like in advance so that the computer 200 may read out the transmission control program from the device and thus execute the transmission control program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission control method executed by a computer, the method comprising:
transmitting first image information that is displayed on a head mounted display to a terminal;
extracting, when designation information for designating a first range included in the first image information is received from the terminal, second image information corresponding to the first range from the first image information; and
transmitting the second image information to the terminal.

2. The transmission control method according to claim 1, wherein the transmitting the first image information to the terminal is processing of reducing resolution of the first image information and transmitting the reduced first image information to the display terminal.

3. The transmission control method according to claim 2, wherein the transmitting the second image information to the terminal is processing of transmitting the second image information to the terminal without reducing resolution of the second image information.

4. The transmission control method according to claim 1, wherein the first range is designated by a certain operation in a display unit of the terminal that has displayed the first image information.

5. The transmission control method according to claim 4, wherein the certain operation is an operation of magnification or reduction.

6. The transmission control method according to claim 1, wherein the designation information is information indicating a first ratio that indicates scaling of an image.

7. The transmission control method according to claim 6, wherein the first range is determined based on the first ratio and a size of first image information.

8. The transmission control method according to claim 1, wherein, in the extracting, when a size of the second image information exceeds a specific image size, the size of the second image information is reduced to the specific image size or less.

9. A transmission control device comprising:
a memory; and
a processor coupled to the memory and the processor configured to:
execute first transmission of first image information that is displayed on a head mounted display to a terminal,
extract, when designation information for designating a first range included in the first image information is received from the terminal, second image information corresponding to the first range from the first image information, and
execute second transmission of the second image information to the terminal.

10. The transmission control device according to claim 9, wherein the first transmission is processing of reducing resolution of the first image information and transmitting the reduced first image information to the display terminal.

11. The transmission control device according to claim 10, wherein the second transmission is processing of transmitting the second image information to the terminal without reducing resolution of the second image information.

12. The transmission control device according to claim 9, wherein the first range is designated by a certain operation in a display unit of the terminal that has displayed the first image information.

13. A non-transitory computer-readable recording medium storing a transmission control program that causes a computer to execute a process comprising:
transmitting first image information that is displayed on a head mounted display to a terminal;
extracting, when designation information for designating a first range included in the first image information is received from the terminal, second image information corresponding to the first range from the first image information; and
transmitting the second image information to the terminal.
